(19) United States
(12) Patent Application Publication
(10) Pub. No.: US 2012/0243158 A1
(43) Pub. Date: Sep. 27, 2012

(54) SELF-POWERED HDMI DONGLE

(76) Inventor: Gregoire Alexandre Gentil, San Francisco, CA (US)

(21) Appl. No.: 13/426,572

(22) Filed: Mar. 21, 2012

Related U.S. Application Data
(60) Provisional application No. 61/466,185, filed on Mar. 22, 2011.

(51) Int. Cl. G06F 1/16

(52) U.S. Cl. 361/679.03; 361/679.02

(57) ABSTRACT

A self-powered apparatus able to deliver an output HDMI signal as well as mix a data input source with a self-generated signal and making the result available as an output HDMI signal.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### FIELD OF THE INVENTION

The present invention is generally related to high definition multimedia interface (HDMI) compatible devices and remotely controlled systems. More specifically, this invention is related to a self-powered apparatus able to deliver an output HDMI signal, as well as mix a data input source with a self-generated signal and making the result available as an output HDMI signal.

### BACKGROUND OF THE INVENTION

HDMI is a complete digitalized audio/video transmission interface for transmitting uncompressed audio and video signals. HDMI technology is now widely used in compatible devices such as DVD player, personal computer, or Internet TV. The HDMI connector is normally able to transmit an HDMI signal, including an audio and video signal, via a single HDMI cable, hence simplifying the system installation.

HDMI and other data sources able to deliver an HDMI signal are generally big devices, like a personal computer, or an Internet Service Provider (ISP) box. Although the initial installation may be easy—one generally needing only a simple cable to connect the data source to the HDMI receiver, the installation is most of the time not easily moveable, either because the HDMI receiver or the data source is not easily moveable. While one can easily carry a USB mass storage dongle in his pocket, it's generally not possible to carry a similar device that would feature an HDMI output connector delivering an HDMI signal.

In the particular case of Internet TV, the HDMI signal is usually generated by a cable box, provided by an Internet Service Provider (ISP). An HDMI cable is then linking the box to the TV, allowing the consumer to watch Internet content directly on his HDMI TV. However, the consumer can't specifically modify the HDMI signal coming from the cable box, this signal content being fully controlled by the ISP through the cable box.

### SUMMARY OF THE INVENTION

The invention is directed to a small electronic device, featuring a single HDMI output connector, small enough to be easily wearable—as a USB mass storage dongle is, and able to produce a self-generated HDMI signal thanks to an internal processing unit.

When connected to an HDMI receiver, this device has the ability to receive and make use of the current available through the HDMI connection. When the current available is not high enough to power the device, an additional battery, or an external power connector, may provide the necessary supplementary current.

This device can optionally receive data inputs, either from a specific data input connector (e.g. HDMI or USB) or from an external data source accessible through a wireless connection. When connected to a data source, this device can perform various operations on it, such as superimposing its own-generated video and audio signals over a video and audio input signal, and output a resulting HDMI signal through its HDMI output connector.

This device can optionally be remotely controlled, either by an infrared remote, or any external control device through wireless connection. That way, this device can be configured to behave the way the user wants to.

### BRIEF DESCRIPTION OF THE DRAWINGS

FIG. 1 is a chart describing the invention in its simplest configuration, i.e. a self-powered HDMI dongle and its interaction with an HDMI receiver.

FIG. 2 is a chart describing the invention in its fullest configuration, i.e. the configuration described in the FIG. 1 with an additional internal battery, data input connector, wireless data source and wireless external control device.

### DETAILED DESCRIPTION OF THE INVENTION

All references cited herein are incorporated by reference in their entirety as though fully set forth. Unless defined otherwise, technical and scientific terms used herein have the same meanings as commonly understood by one of ordinary skill in the art to which this invention belongs. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The present invention relates to HDMI compatible electronic devices and remotely controlled systems, and more specifically to a conveniently small apparatus able to deliver an output HDMI signal, and pluggable into an HDMI compatible receiver device.

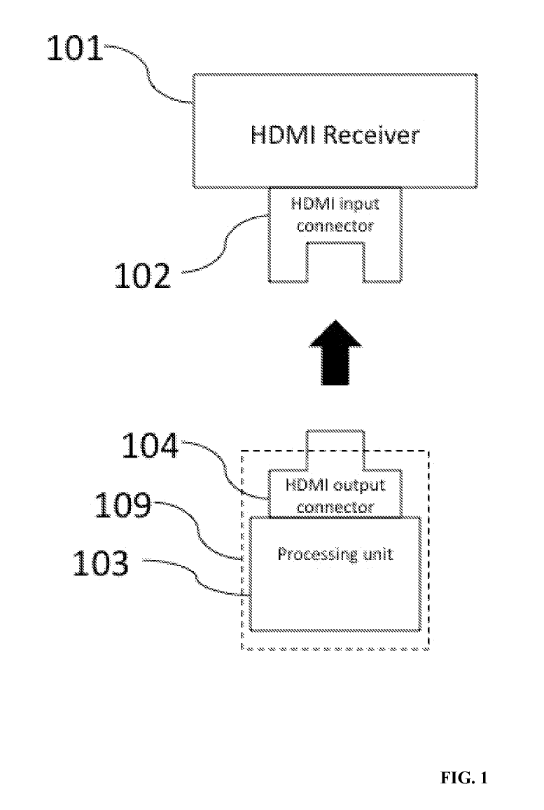

Referring now to the invention in more detail, in FIG. 1 is shown a chart describing the self-powered HDMI dongle 109 in its simplest configuration, i.e. consisting of the HDMI dongle processing unit 103 and the HDMI output connector 104. It has the ability to be connected to a HDMI receiver 101 through an HDMI input connector 102. According to the HDMI standard, a minimum current of 50 mA should be made available by the HDMI receiver 101 through its HDMI connector 102. In some cases such as HDMI televisions, the actual available current is much greater, so that the HDMI dongle processing unit 103 doesn't need any additional power to work. In this case, the HDMI dongle 109 doesn't need any additional battery, and just needs to be plugged to the HDMI receiver 101 to deliver its HDMI output signal.

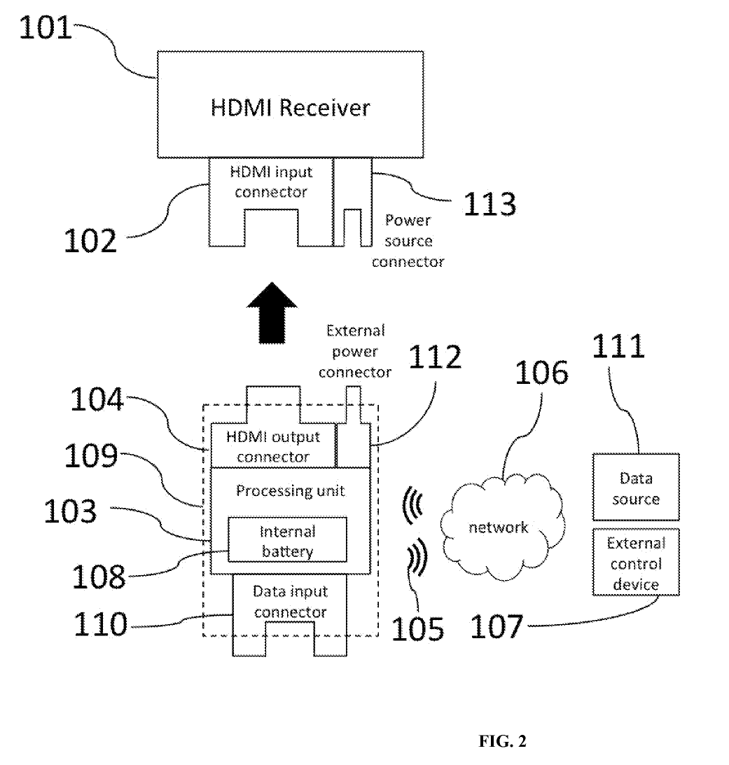

However, as shown on FIG. 2, in the case the minimum requirement 50 mA is just strictly respected or more generally when the HDMI dongle 109 needs more current to be turned on than the one provided by the HDMI receiver 101, an internal battery 108 can power the HDMI dongle processing unit 103, allowing it to work as expected. The internal battery 108 can then be charged thanks to a higher current available from another HDMI receiver 101. Similarly, as shown on FIG. 2, the external power connector 112 can be plugged into the power source connector 113 provided by the HDMI receiver, so that the HDMI dongle processing unit 103 is correctly powered. Such a power connector can typically be a USB connector, as the specifications suggest that a current of 500 mA can be available. That way, one doesn't need to carry any power adapter to plug into the device: only the HDMI receiver 101 will charge the internal battery 108.

The FIG. 2 shows another optional part for this device, being the data input connector 110. Through this interface, the device can acquire a signal from any data source complying with the interface of the input connector 110. Common examples of such an input connector 110 are HDMI or USB connectors, but can actually be of any kind. The data source can be as well any kind of device, like a digital cable box provided by an Internet Service Provider (ISP) or any computer able to output a compliant data signal. In that case, the HDMI dongle 109 can perform signal modifications thanks to its full internal processing unit 103, including, but not limited to, superimposition of a self-generated video or audio signal over the original signal. The HDMI dongle 109 can also acquire such a data input signal from a physically disconnected data source 111, connected to it via a wireless connection 105, being direct or carried through a specific network 106. The main purpose on the invention is here to allow a dynamic enrichment of the contents generated by the data source, thanks to a physical connection on the data input connector 110 or a wireless connection 105. Such additional content can be for example contextual advertising streams, or user content stored on his personal network.

The HDMI dongle 109 can be configured and controlled by the user, thanks to any external control device able to communicate with it thanks to a wireless connection 105. Examples of such an external control device are an infrared remote, a mobile phone, or any wireless laptop. It is noted that the HDMI dongle 109 can filter the initial signal according to specific user rules, or just be transparent and reproduce the initial data input acquired to its HDMI output connector 104. Many configuration options can be accessed and set up, such as what content to filter or not in the input signal, what type of network accesses the HDMI dongle 109 is granted, or what content is allowed to be added to the initial input signal generated by the data source 111.

The construction details of the invention as shown on FIG. 1 and FIG. 2 are that the dimensions and weight of the self-powered HDMI dongle 109 (i.e. including the HDMI dongle processing unit 103, the HDMI output connector 104, the internal battery 108, and the data input connector 110), may be small enough to allow it to be easily wearable without any additional equipment.

I claim:

1. An electronic device, comprising:
a case, which dimensions are small enough to allow said electronic device to be easily wearable without any additional equipment;
an HDMI output connector;
a computing system, able to be powered through said HDMI output connector when connected, and able to produce a self-generated HDMI signal, and make it available through said HDMI output connector.

2. The electronic device as recited in claim 1, further including an internal battery and a battery system, powering said computing system when needed, and able to charge the battery through said HDMI output connector when connected.

3. The electronic device as recited in claim 1, further including an external power connector, said external power connector being able to be plugged into a compatible power source connector so that said computing system get enough current to be correctly powered.

4. The electronic device as recited in claim 1, said device being configurable so that one can choose what content said computing system can access to generate an HDMI signal.

5. The electronic device as recited in claim 1, further including an external control device, said external control device being able to communicate with said electronic device thanks to a wireless connection.

6. An electronic device, comprising:
a case;
a data input connector;
an HDMI output connector;
a computing system, able to perform computing operations on an input data signal available through said data input connector, and make the result available through said HDMI output connector.

7. The electronic device as recited in claim 5, further including an internal battery and a battery system, powering said computing system when needed, and able to charge the battery through said HDMI output connector when connected.

8. The electronic device as recited in claim 5, said device being configurable so that one can choose what content said computing system can access to generate an HDMI signal.

9. The electronic device as recited in claim 5, further including an external control device, said external control device being able to communicate with said electronic device thanks to a wireless connection.
